(19) United States
(12) Patent Application Publication
(10) Pub. No.: US 2009/0159623 A1
(43) Pub. Date: Jun. 25, 2009

(54) STORAGE COMPARTMENT

(76) Inventor: Peter Kreutmayr, Tubingen (DE)

Correspondence Address: MICHAEL J. STRIKER, 103 EAST NECK ROAD, HUNTINGTON, NY, 11743, US

(21) Appl. No.: 12/330,081

(22) Filed: Dec. 8, 2008

(30) Foreign Application Priority Data
Dec. 20, 2007 (DE) 10 2007 061 898.2

(51) Int. Cl. B60R 7/00

(52) U.S. Cl. 224/282

(57) ABSTRACT

A storage compartment, especially to a holder for holding a drinks container, such as, for example, a beverage can, so that it does not tip over, in a motor vehicle, for matching to different drinks container diameters, has a compartment divider which can be pivoted inwards and, on the outside of the compartment divider, a support which has a parallel offset pivot axis and a return blocker which supports the compartment divider against pivoting out from the container receptacle.

### CROSS-REFERENCE TO RELATED APPLICATION

The invention described and claimed hereinbelow is also described in German Patent Application DE 10 2007 061 898.2 filed on Dec. 20, 2007. This German Patent Application, whose subject matter is incorporated here by reference, provides the basis for a claim of priority of invention under 35 U.S.C. 119(a)-(d).

### BACKGROUND OF THE INVENTION

The present invention relates to a storage compartment.

Storage compartments of such a kind, for keeping articles such as, for example, spectacles, pens, notepads and small items in motor vehicles, are known. They can also be used in other land, air and sea vehicles. The known storage compartments are in the form of dishes, open to the top, which can be installed, for example, in the central console on the transmission tunnel of a motor vehicle. Indications of spatial directions such as “top” refer to the position in which the storage compartment is intended to be installed and used.

Sometimes it is desirable for the storage compartment to be made smaller or sub-divided. For that purpose there are known, inter alia, pivotal compartment dividers, which can be pivoted into and out of the storage compartment, the compartment dividers, when in the position pivoted out from the storage compartment, lying, for example, against the inside of a peripheral wall of the storage compartment or in a depression or gap in the peripheral wall of the storage compartment.

A storage compartment which is oval in a top view, having a compartment divider that can be pivoted about a vertical pivot axis, is known from EP 1 304 257 A2. The compartment divider is in the form of a curved plate, the curvature of the compartment divider corresponding to the curvature of a peripheral wall of the storage compartment. The compartment divider can be pivoted into the storage compartment so that it separates off a part at one end of the storage compartment in which it is possible, for example, for a drinks container such as a drinks can to be inserted.

In the opposite direction, the storage compartment can be pivoted out from the storage compartment into a gap in the peripheral wall of the storage compartment so that the compartment divider is flush with the peripheral wall of the storage compartment. A click-in catch device with a toothed arrangement holds the compartment divider in its particular pivoted position. By pushing down the compartment divider against the force of a spring element, the click-in catch device can be disengaged so that the compartment divider can be pivoted in the manner described.

### SUMMARY OF THE INVENTION

Accordingly, it is an object of the present invention to propose a storage compartment having a compartment divider of the kind described hereinbefore with a modified fixing device for the compartment divider.

The storage compartment according to the invention has a compartment divider and a support which, like the compartment divider, has a pivotal mounting by which it is mounted so that it can be pivoted into the storage compartment and out from the storage compartment. In this context the expression “out from” does not necessarily mean a position outside the storage compartment but basically means a second position which also may be located within the storage compartment.

The pivot axes of the pivotal mounting of the compartment divider and of the pivotal mounting of the support are spaced apart from one another so that the compartment divider and the support move relative to one another when they are pivoted into the storage compartment and out from the storage compartment. The storage compartment according to the invention furthermore has a return blocker for the support which allows the support to pivot or, in general terms, to move in one direction and blocks backward movement. The return blocker can have sawtooth-shaped holding notches with which a locking pawl or the like co-operates, as known from hand-brake levers of motor vehicles. Other, interlocking or friction-based return blockers are also possible. It is intended for the return blocker to block movement of the support out from the storage compartment, although blocking in the opposite direction is also basically possible.

The support pivots into the storage compartment with the compartment divider and, by virtue of the return blocker, supports the compartment divider against backward movement, that is to say against pivoting of the compartment divider out from the storage compartment. By that means, a region of the storage compartment can be separated off, the size of the separated-off region being adjustable preferably steplessly or in steps. In order to pivot the compartment divider out from the storage compartment, the return blocker must be released.

The return blocker can be arranged in a fixed location at the storage compartment, especially at a peripheral wall of the storage compartment, so that when the compartment divider is being pivoted the support moves along the return blocker. In accordance with an embodiment of the invention, the return blocker is arranged between the compartment divider and the support. “Between” is meant in regard to action; for example, the holding notches are arranged or formed on the compartment divider and one end of the support is in the form of a pawl co-operating with the holding notches or has a pawl.

In accordance with an embodiment of the invention, the compartment divider is resiliently biased towards the outside. In order to separate off a part of the storage compartment, the compartment divider is pivoted into the storage compartment against its resilient biasing. The return blocker blocks against the resiliently biased compartment divider being pivoted back towards the outside. The compartment divider pivots outwards only after the return blocker has been released.

In accordance with a further, or other, embodiment of the invention, the compartment divider is resiliently biased against the support or, vice versa, the support is resiliently biased against the compartment divider. As a result, the return blocker is brought into or held in engagement, at any rate when it is arranged at the compartment divider and support.

In accordance with an embodiment of the invention, the pivotal mountings of the compartment divider and of the support are arranged at those ends thereof which are close to one another, the pivot axes of the pivotal mountings being spaced apart from one another. As a result, the compartment divider and the support pivot approximately parallel to one another and can be accommodated using little installation space. On pivoting, the compartment divider and the support move relative to one another so that the return blocker is active and allows pivoting in only one direction, preferably into the storage compartment, and blocks pivoting out.

In accordance with an embodiment of the invention, the compartment divider and the support are of plate form and arranged against one another or in one another. The compartment divider and the support especially have the shape of the peripheral wall of the storage compartment in that region where they are arranged.

In accordance with an embodiment of the invention, the storage compartment has a holder for a drinks container such as a can, a beaker or a bottle. Such holders are also referred to as “cup holders”. The storage compartment itself can be the holder, or a region of the storage compartment can be separated off using the compartment divider, which region forms a container receptacle—open to the top—in which a drinks container can be inserted, and which region forms the holder for the drinks container. When not being used as a holder for a drinks container, the compartment divider is pivoted outwards so that all the storage compartment is available. By pivoting the compartment divider, the clear width of a container receptacle of the holder can be adjusted, which receptacle serves for insertion of a drinks container. The compartment divider in that case forms a diameter-compensating element, by means of which the storage compartment and/or the holder can be matched to different drinks container diameters.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows, in a perspective view at an angle from above, a holder for a drinks container in the form of a storage compartment according to the invention;

FIG. 2 shows the holder of FIG. 1 with an inwardly pivoted compartment divider;

FIG. 3 shows the holder of FIG. 1 in a partly broken-open view in a radial viewing direction from the outside; and

FIG. 4 shows the holder of FIG. 1 in a cross-sectional view in an axial viewing direction.

### DESCRIPTION OF THE PREFERRED EMBODIMENTS

The holder 1 shown in the drawings is intended for installation in a motor vehicle (not shown) and is used for holding a drinks container such as, for example, a drinks can, a beaker or a bottle so that it does not tip over. Such holders 1 are also referred to as “cup holders”. The holder 1 forms a storage compartment according to the invention.

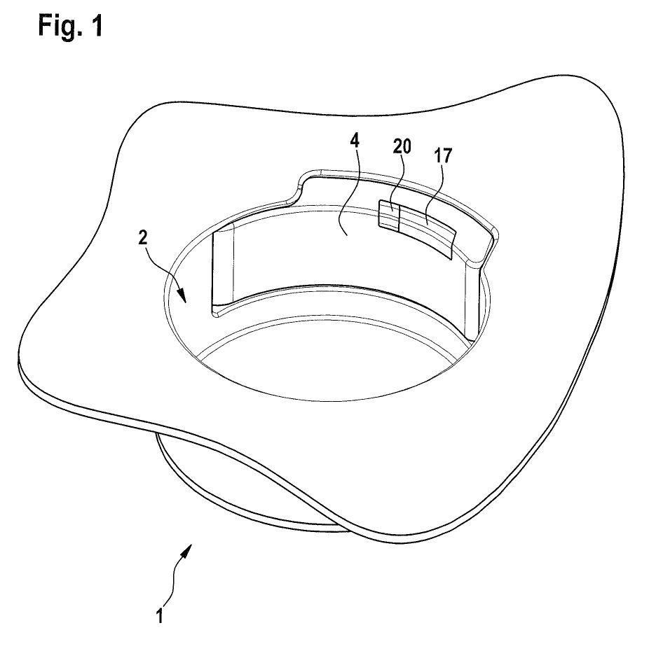

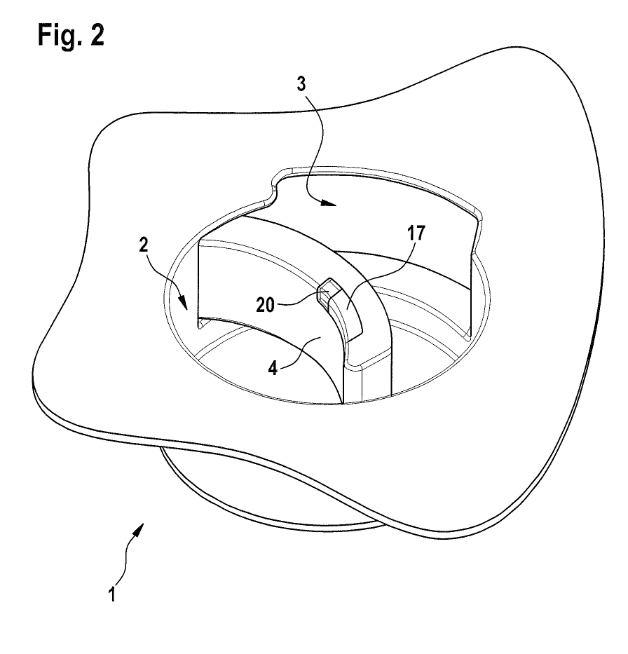

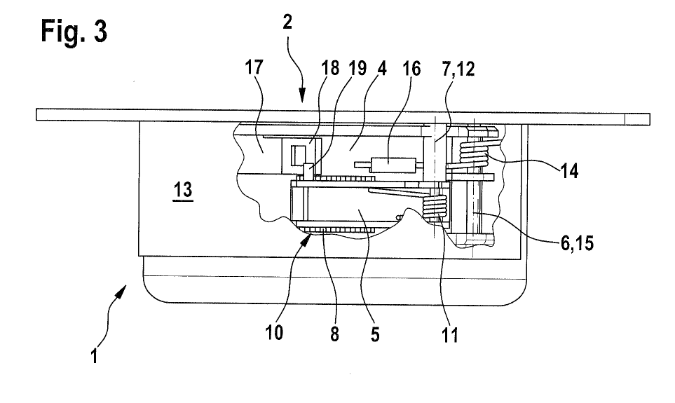

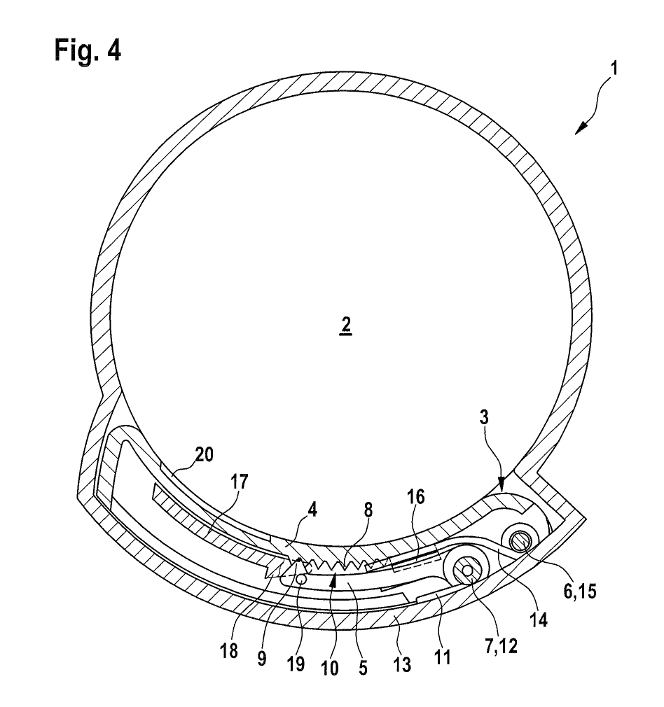

The holder 1 has a bowl-shaped depression forming a container receptacle 2 for inserting a drinks container (not shown). In a peripheral wall, the container receptacle 2 has a recess 3, which extends in the peripheral direction over an arc of more than a quarter-circle and extends over about ¾ of the height of the container receptacle 2. Arranged in the recess 3 are a compartment divider 4 of plate form and a support 5 (see FIGS. 3 and 4 for the support 5). The compartment divider 4 has the same curvature as the peripheral wall of the container receptacle 2 and, when it has been pivoted outwards, is flush with the peripheral wall, as can be seen in FIGS. 1 and 4. It can be pivoted into the container receptacle 2 of the holder 1, as can be seen in FIG. 2. The support 5 is arranged on the outside of the compartment divider 4 and also extends in an arc of a circle in the peripheral direction. In this example of an embodiment, the support 5 is only about half as long as the compartment divider 4, but this is not mandatory for the invention.

The compartment divider 4 and the support 5 each have a pivotal mounting 6, 7 (FIGS. 3 and 4), the pivot axes of which extend parallel to one another and axially parallel to the container receptacle 2. The pivotal mountings 6, 7 are arranged on the outsides of the compartment divider 4 and of the support 5; their pivot axes are spaced apart from one another in the peripheral direction of the container receptacle 2.

The compartment divider 4 has a toothed arrangement 8, like a toothed rack, extending with a circular curvature in the peripheral direction. The toothed arrangement 8 is arranged on the outside of the compartment divider 4 facing the support 5 and co-operates with a locking pawl 9 on the support 5. The locking pawl 9 is in the shape of a tooth corresponding to the toothed arrangement 8 and is located on an end of the support 5 which is remote from the pivotal mounting 7 of the support 5, on the inside of the support 5 facing the compartment divider 4 and its toothed arrangement 8. The pivotal mountings 6, 7 are provided on ends of the compartment divider 4 and of the support 5 which are close to one another. The locking pawl 9 and the toothed arrangement 8 form a return blocker 10 which will be explained later.

A spring element 11 biases the support 5 against the compartment divider 4 and holds the locking pawl 9 in engagement—or brings it into engagement—with the toothed arrangement 8. In this example of an embodiment, the spring element 11 is a helical leg spring, the coil of which is arranged on a shaft 12 of the pivotal mounting 7 of the support 5. A leg of the spring element 11 in the form of a helical leg spring abuts the inside of a wall 13 which surrounds, on the outside, the recess 3, in which the compartment divider 4 and the support 5 are arranged. The other leg of the spring element 11 abuts the support 5 from the outside. The spring element 11, acting as a torsion spring, biases the support 5 into the container receptacle 2, that is to say against the compartment divider 4.

A further spring element 14 biases the compartment divider 4 outwards from the container receptacle 2. In this example of an embodiment, this spring element 14 is also in the form of a helical leg spring, the coil of which is accommodated on a shaft 15 of the pivotal mounting 6 of the compartment divider 4. A leg of the spring element 14 abuts the inside of the wall 13 which surrounds the recess 3. The other leg of the spring element 14 is accommodated in a holder 16 of L-shaped cross-section on the outside of the compartment divider 4, so that the spring element 14 can bias the compartment divider 4 outwards.

In order to make the clear width of the container receptacle 2 smaller, the compartment divider 4 is pivoted, against the force of its spring element 14, inwards into the container receptacle 2. As described, the spring element 11 of the support 5 biases the support 5 inwards, that is to say against the outside of the compartment divider 4, so that the support 5 pivots inwards with the compartment divider 4. Because the pivot axes of the pivotal mountings 6, 7 of the compartment divider 4 and of the support 5 are spaced apart from one another, the compartment divider 4 and the support 5 move relative to one another when pivoted. As a result, the locking pawl 9 at the end of the support 5 comes out of engagement with the toothed arrangement 8 and advances one tooth of the toothed arrangement 8 at a time.

When the compartment divider 4 is released, the locking pawl 9 comes into engagement with the toothed arrangement 8 on the compartment divider 4 so that the support 5 blocks backward movement, that is to say outwards pivoting, of the compartment divider 4 by means of the toothed arrangement 8 and the locking pawl 9. As already stated, the toothed arrangement 8 and the locking pawl 9 form a return blocker 10. The compartment divider 4 can, as described, be pivoted into the container receptacle 2 tooth by tooth of the toothed arrangement 8, that is to say in steps. As a result, the clear width of the container receptacle 2, that is to say the spacing between the compartment divider 4 and a region of the peripheral wall of the container receptacle 2 that is located opposite, can be adjusted and matched to the diameter of a drinks container (not shown) that is to be or has been inserted.

For release, the return blocker 10 has a slider 17 which is curved in an arc of a circle like the compartment divider 4 and displaceably guided in the peripheral direction on the outside of the compartment divider 4. The slider 17 has a wedge 18 on one of its ends which engages underneath an upwardly projecting, pin-shaped lifter 19 on the support 5. When the wedge 18 is displaced with the slider 17, the wedge 18 pushes the support 5 outwards away from the compartment divider 4 by means of the lifter 19. As a result, the locking pawl 9 comes out of engagement with the toothed arrangement 8, and the spring element 14 pivots the compartment divider 4 outwards from the container receptacle 2 into the position shown in FIGS. 1, 3 and 4, in which the compartment divider 4 is located in the recess 3 flush with the peripheral wall of the container receptacle 2.

The support 5 is pivoted outwards with the compartment divider 4. The slider 17 is then moved back so that the wedge 18 moves out between the lifter 19 and the compartment divider 4 to an extent such that the spring element 11 again pivots the support 5 against the compartment divider 4 from the outside and by that means brings the locking pawl 9 into engagement with the toothed arrangement 8. The slider 17 is accessible through an opening 20 which extends some distance in the peripheral direction at an upper inner edge of the compartment divider 4 (FIGS. 1, 2). FIG. 2 shows the end position of the compartment divider 4 pivoted to the furthest extent into the container receptacle 2. The compartment divider 4 forms a diameter-compensating element.

It will be understood that each of the elements described above, or two or more together, may also find a useful application in other types of constructions differing from the types described above.

While the invention has been illustrated and described as embodied in a storage compartment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A storage compartment, comprising a compartment divider; a first pivotal mounting by which said compartment divider is mounted so that it is pivotable into the storage compartment and out from the storage compartment; a support; a second pivotal mounting by which said support is mounted so that it is pivotable into the storage compartment and out from the storage compartment, wherein pivot axes of said pivotal mountings are spaced apart from one another, and wherein said support has a return blocker which allows pivoting in one direction and blocks backward movement.

2. A storage compartment as defined in claim 1, wherein said return blocker is arranged at said compartment divider and said support.

3. A storage compartment as defined in claim 1, wherein said compartment divider and said support are arranged in a way selected from the group consisting of said compartment divider is resiliently biased towards the outside, said compartment divider and said support are resiliently biased against one another, and both.

4. A storage compartment as defined in claim 1, wherein said pivotal mountings are arranged at ends, close to one another, of said compartment divider and said support.

5. A storage compartment as defined in claim 1, wherein said compartment divider and said support are plate-shaped and located in a position selected from the group consisting of against one another and in one another.

6. A storage compartment as defined in claim 1, wherein the storage compartment is a holder for a beverage container, wherein a clear width of the container receptacle is adjustable using said compartment divider.
